(19) United States
(12) Patent Application Publication
(10) Pub. No.: US 2023/0174357 A1
(43) Pub. Date: Jun. 8, 2023

(54) Tiltable Machine Liftable Trash Collection Assembly

(71) Applicant: Raul Mendez, Carrollwood, FL (US)

(72) Inventor: Raul Mendez, Carrollwood, FL (US)

(21) Appl. No.: 17/545,096

(22) Filed: Dec. 8, 2021

(51) Int. Cl. B66F 9/06

(52) U.S. Cl. CPC B66F 9/06

(57) ABSTRACT

A tiltable machine liftable trash collection assembly for reducing manual lifting and incidence of injury includes a skid and a container. The skid is liftable by a pallet lifting machine, such as a forklift, a skid jack, a front loader, or the like. A pair of arms is engaged to the skid so that the arms extend singly from adjacent corners of the skid. A rod is engaged to and extends between the arms distal from the skid. The container is pivotally engaged to the rod so that a bottom of the container rests upon the skid. A top of the container is open, allowing for positioning of refuse. The skid can be selectively lifted by the pallet lifting machine, positioning an operator to tilt the container so that the refuse empties through the top of container without the operator having to manually lift the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trash collection assemblies and more particularly pertains to a new trash collection assembly for reducing manual lifting and incidence of injury.

The present invention discloses a trash collection assembly comprising a skid to which a container is pivotally engaged. The skid is selectively engageable to a pallet lifting machine and the container is tiltable relative to the skid so that the container can be emptied without it being lifted.

### (2) Description of Related Art Including Information Disclosed Under 37 CFR 1.97 and 1.98

The prior art relates to trash collection assemblies. The prior art comprises containers having opening allowing for insertion of forks and machines for lifting and tilting containers. What is lacking in the prior art is a trash collection assembly comprising a skid to which a container is pivotally engaged. The skid is selectively engageable to a pallet lifting machine and the container is tiltable relative to the skid so that the container can be emptied without it being lifted.

### BRIEF SUMMARY OF THE INVENTION

An embodiment of the disclosure meets the needs presented above by generally comprising a skid and a container. The skid is configured to be lifted by a pallet lifting machine, such as a forklift, a skid jack, a front loader, or the like. A pair of arms is engaged to the skid so that the arms extend singly from adjacent corners of the skid. A rod is engaged to and extends between the arms distal from the skid. The container is pivotally engaged to the rod so that a bottom of the container rests upon the skid. A top of the container is open, thus the container is configured for positioning of refuse. The skid is configured to be selectively lifted by the pallet lifting machine, positioning an operator to tilt the container so that the refuse empties through the top of container without the operator having to manually lift the container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a tiltable machine liftable trash collection assembly according to an embodiment of the disclosure.

FIG. 2 is a side view of an embodiment of the disclosure.

FIG. 3 is a front view of an embodiment of the disclosure.

FIG. 4 is a bottom view of an embodiment of the disclosure.

FIG. 5 is an in-use view of an embodiment of the disclosure.

### DETAILED DESCRIPTION OF THE INVENTION

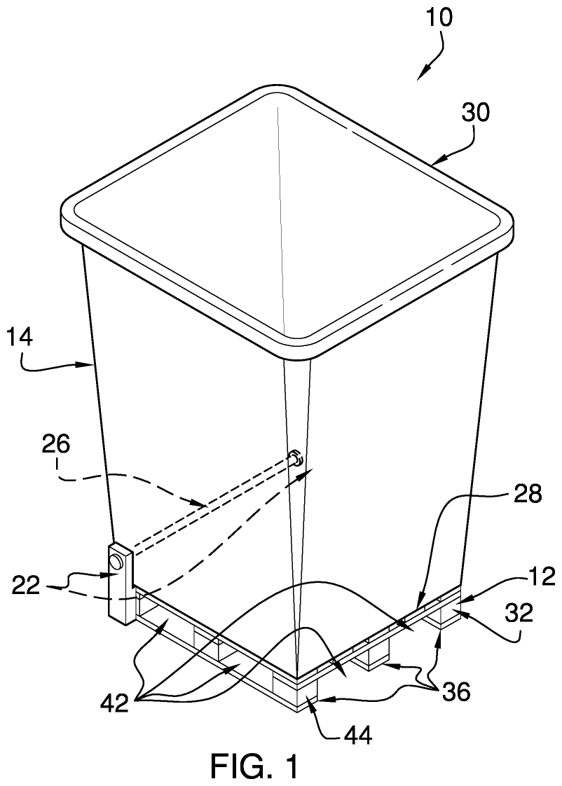

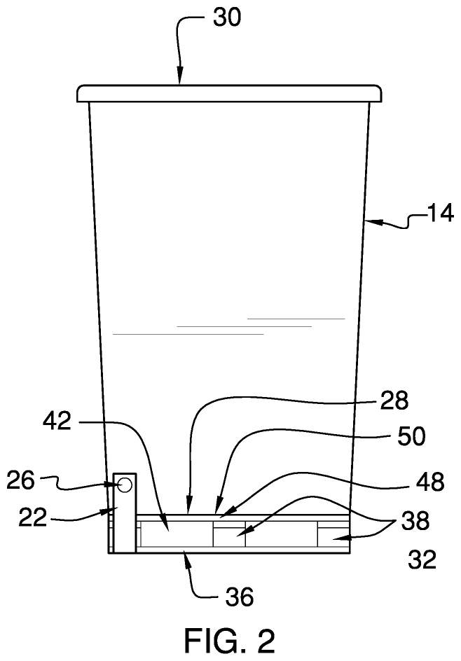

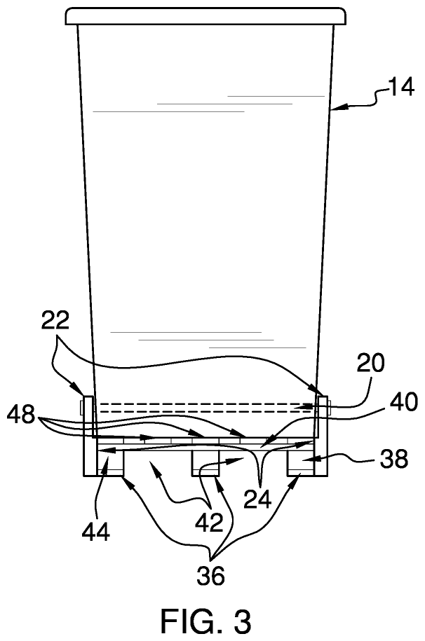

With reference now to the drawings, and in particular to FIGS. 1 through 5 thereof, a new trash collection assembly embodying the principles and concepts of an embodiment of the disclosure and generally designated by the reference numeral 10 will be described.

As best illustrated in FIGS. 1 through 5, the tiltable machine liftable trash collection assembly 10 generally comprises a skid 12 and a container 14. The skid 12 is configured to be lifted by a pallet lifting machine 18, such as a forklift 20, a skid jack (not shown), a front loader (not shown), or the like. A pair of arms 22 is engaged to the skid 12 so that the arms 22 extend singly from adjacent corners 24 of the skid 12. A rod 26 is engaged to and extends between the arms 22 distal from the skid 12.

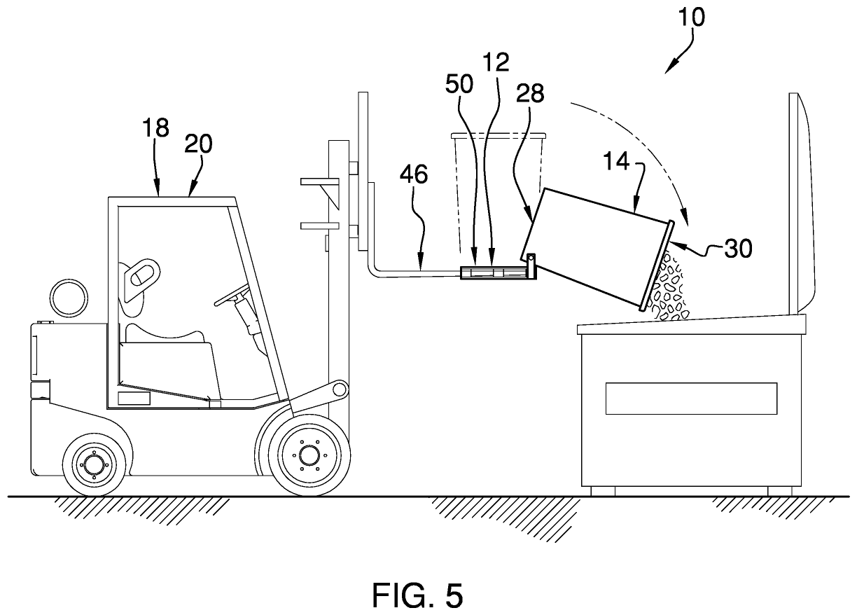

The container 14 is pivotally engaged to the rod 26 so that a bottom 28 of the container 14 rests upon the skid 12. A top 30 of the container 14 is open, thus the container 14 is configured for positioning of refuse. A lid (not shown) may be hingedly engaged to the container 14 proximate to the top 30 to selectively close the top 30. The skid 12 is configured to be selectively lifted by the pallet lifting machine 18, positioning an operator to tilt the container 14 so that the refuse empties through the top 30 of container 14 without the operator having to manually lift the container 14. The present invention is anticipated to be useful in emptying a container 14 of refuse into a larger refuse receptable, such as a dumpster, as shown in FIG. 5. Relieving the operator from manually lifting the container 14 reduces strain on the muscles and joints of the operator and resulting risk of injury.

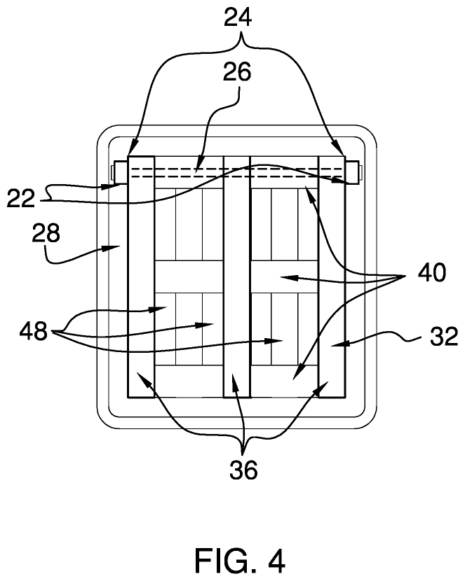

The skid 12 may be rectangular, or, as shown in FIG. 4, square. The skid 12 may comprise a stringer pallet (not shown), or as shown in FIGS. 1-5, a block pallet 32. The skid 12 comprises a set of three bottom deckboards 36, which are arranged in parallel. A plurality of blocks 38 is engaged to the bottom deckboards 36 so that the blocks 38 are positioned three apiece and substantially evenly spaced on each bottom deckboard 36. Each of a set of three stringer boards 40 is engaged to and extends between respective blocks 38, distal from the bottom deckboards 36, so that the stringer board 40 is perpendicular to the bottom deckboards 36. The bottom deckboards 36, the blocks 38, and the stringer boards 40 define a plurality of openings 42. The openings 42 are positioned two apiece in each side 44 of the skid 12. Openings 42 positioned in a respective side 44 are configured for insertion of tines 46 of the pallet lifting machine 18. Each of a plurality of top deckboards 48 is engaged to and extends between the stringer boards 40. The plurality of top deckboards 48 defines an upper surface 50 of the skid 12.

In use, refuse is collected in the container 14 until emptying of the container 14 is required. The pallet lifting machine 18 then is engaged to the skid 12 and is used to lift the skid 12, the container 14, and the refuse. The container 14 then can be tilted by an operator so that the refuse empties through the top 30 of container 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tiltable machine liftable trash collection assembly comprising:
a skid configured for lifting by a pallet lifting machine, said skid having an outer peripheral edge;
a pair of arms engaged to the skid, said pair of arms abutting the peripheral edge of the skid on opposite sides of the skid, such that the arms extend singly from adjacent corners of the skid;
a rod engaged to and extending between the arms distal from the skid wherein the rod is positioned vertically spaced above the skid; and
a container pivotally engaged to the rod, such that a bottom of the container rests upon the skid, a top of the container being open, wherein the container is configured for positioning of refuse, wherein the skid is configured for being selectively lifted by the pallet lifting machine, positioning an operator for tilting the container such the refuse empties through the top of container.

2. The tiltable machine liftable trash collection assembly of claim 1, wherein the skid is rectangular.

3. The tillable machine liftable trash collection assembly of claim 2, wherein the skid is square.

4. The tiltable machine liftable trash collection assembly of claim 2, wherein the skid comprises a stringer pallet or a block

5. The tiltable machine liftable trash collection assembly of claim 4, wherein the skid comprises:
a set of three bottom deckboards arranged in parallel;
a plurality of blocks engaged to the bottom deckboards such that the blocks are positioned three apiece and substantially evenly spaced on each bottom deckboard;
a set of three stringer boards, each stringer board being engaged to and extending between respective blocks distal from the bottom deckboards, such that the stringer board is perpendicular to the bottom deckboards, such that the bottom deckboards, the blocks, and the stringer boards define a plurality of openings, the openings being positioned two apiece in each side of the skid, wherein openings positioned in a respective side are configured for insertion of tines of the pallet lifting machine; and
a plurality of top deckboards, each top deckboard being engaged to and extending between the stringer boards, such that the plurality of top deckboards defines an upper surface of the skid.

6. A tiltable machine liftable trash collection system comprising:
a pallet lifting machine;
a skid operationally engaged to the pallet lifting machine, said skid having an outer peripheral edge, such that the skid is selectively liftable by the pallet lifting machine;
a pair of arms engaged to the skid, said pair of arms abutting the peripheral of the skid on opposite sides of the skid, such that the arms extend singly from adjacent corners of the skid;
a rod engaged to and extending between the arms distal from the skid wherein the rod is positioned vertically spaced above the skid; and
a container pivotally engaged to the rod, such that a bottom of the container rests upon the skid, a top of the container being open, wherein the container is configured for positioning of refuse, positioning the pallet lifting machine for lifting the skid, wherein the container is configured for being tilted by an operator, such the refuse empties through the top of container.

7. The tiltable machine liftable trash collection system of claim 6, wherein the pallet lifting machine comprises a forklift, a skid jack, or a front loader,

8. The tiltable machine liftable trash collection system of claim 6, wherein the skid is rectangular.

9. The tillable machine liftable trash collection system of claim 8, wherein the skid is square.

10. The tiltable machine liftable trash collection system of claim 8, wherein the skid comprises a stringer pallet or a block

11. The tiltable machine liftable trash collection system of claim 10, wherein the block pallet comprises:
a set of three bottom deckboards arranged in parallel;
a plurality of blocks engaged to the bottom deckboards such that the blocks are positioned three apiece and substantially evenly spaced on each bottom deckboard;
a set of three stringer boards, each stringer board being engaged to and extending between respective blocks distal from the bottom deckboards, such that the stringer board is perpendicular to the bottom deckboards, such that the bottom deckboards, the blocks, and the stringer boards define a plurality of openings, the openings being positioned two apiece in each side of the skid, such that tines of the pallet lifting machine are insertable into the skid from any of the sides; and
a plurality of top deckboards, each top deckboard being engaged to and extending between the stringer boards, such that the plurality of top deckboards defines an upper surface of the skid.

12. A liftable machine liftable trash collection assembly comprising:
a skid configured for lifting by a pallet lifting machine, the skid having an outer peripheral edge the skid being rectangular, the skid comprising a stringer pallet or a block pallet, the skid comprising:
a set of three bottom deckboards arranged in parallel,
a plurality of blocks engaged to the bottom deckboards such that the blocks are positioned three apiece and substantially evenly spaced on each bottom deckboard,
a set of three stringer boards, each stringer board being engaged to and extending between respective blocks distal from the bottom deckboards, such that the stringer board is perpendicular to the bottom deckboards, such that the bottom deckboards, the blocks, and the stringer boards define a plurality of openings, the openings being positioned two apiece in each side of the skid, wherein openings positioned in a respective side are configured for insertion of tines of the pallet lifting machine, and
a plurality of top deckboards, each top deckboard being engaged to and extending between the stringer boards, such that the plurality of top deckboards defines an upper surface of the skid;
a pair of arms engaged to the skid, said pair of arms abutting the peripheral edge of the skid on opposite sides of the skid, such that the arms extend singly from adjacent corners of the skid;
a rod engaged to and extending between the arms distal from the skid wherein the rod is positioned vertically spaced above the skid; and
a container pivotally engaged to the rod, such that a bottom of the container rests upon the skid, a top of the container being open, wherein the container is configured for positioning of refuse, wherein the skid is configured for being selectively lifted by the pallet lifting machine, positioning an operator for tilting the container such the refuse empties through the top of container.
